(19) United States
(12) Patent Application Publication
(10) Pub. No.: US 2012/0133727 A1
(43) Pub. Date: May 31, 2012

(54) SCREEN SHARING AND VIDEO CONFERENCING SYSTEM AND METHOD

(75) Inventors: Robert Bolduc, Senneville (CA); Katharina Bauer-Öppinger, Gramastetten (AT); Jean-François Lavallée, Montreal (CA); Vincent Siveton, Montreal (CA); Sacha Leprêtre, Vercheres (CA)

(73) Assignee: CENTRE DE RECHERCHE INFORMATIQUE DE MONTREAL INC., Montreal (CA)

(21) Appl. No.: 13/304,682

(22) Filed: Nov. 27, 2011

Related U.S. Application Data
(60) Provisional application No. 61/417,397, filed on Nov. 26, 2010.

(30) Foreign Application Priority Data
Nov. 26, 2010 (CA) 2722460

(51) Int. Cl. H04N 7/15

(52) U.S. Cl. 348/14.07; 348/E07.083

(57) ABSTRACT

A screen sharing and video conferencing method and system comprising a presenter device, one or more attendee devices and a streaming server for receiving and rebroadcasting video and audio streams from the presenter and the attendee devices. The presenter device and the attendee devices each comprise a browser-based video and audio streaming components configured to transmit camera video and microphone audio to the streaming server and playback video and audio streams from the streaming server. The presenter device further comprises an installed screen capture and system audio capture component configured to compress and transmit video data from a desktop and/or video source of the presenter device and to transmit system audio to the streaming server. The attendee devices further receive video and audio streams from the streaming server of camera, microphone, system audio and screen capture sources.

### TECHNICAL FIELD

The present invention relates to a screen sharing and video conferencing system and method between computing devices connected to a network. More particularly, the invention relates to a screen sharing and video conferencing system and method where video and audio information may be efficiently transmitted between the computing devices.

### BACKGROUND

Due to the wide application of the network communication technology, screen sharing has become an important application of the computer system. In order to share the screen display of a local computer, the screen display information needs to be transmitted through a communication network, such as the internet, to a remote computer and displayed on the screen of the remote computer.

Screen sharing between computing devices has countless practical applications. For one, screen sharing enables remote technical support. Another practical use is collaboration between a host and a viewer. A host can give a presentation to one or more remote viewers. Moreover, screen sharing allows to perform demonstrations, review documents, provide file access and share images.

Extensive research and development has been done in this field, hoping that data to be transmitted in sharing the screen display may be reduced and that the transmission time and bandwidth may be saved while maintaining a desired level of image quality.

U.S. Patent Application No. 2002/0054044 discloses a collaborative screen sharing system where data to be transmitted form a local computer to a remote computer is reduced by redisplaying unchanged images. The system provides a unit block dividing and caching mechanism in the local computer and in each remote computer that shares the screen display of the local computer. A screen display to be displayed in the local computer is first compared with a previous screen display. The differences between the screen display to be displayed and the previous screen display is then divided into unit blocks. Unit blocks of the differences are then compared with the stored unit blocks for determining the unit blocks to be transmitted to the remote computer.

Such a system may be effective in sharing a screen that has a large amount of screen portions that remain unchanged. However, such a system would be ineffective to share a screen that displays images that have a large amount of screen portions that change at a very frequent rate such as in a real time video file transmission.

### SUMMARY

It has been discovered that it is possible, in a screen sharing and video conferencing system, to provide streaming of a captured video stream at an adjusted frame rate so as to maintain a desired video stream quality at a receiving device and still remain within an available bandwidth limit.

It has been discovered that it is possible, in a screen sharing and video conferencing system, to multiplex a plurality of captured video stream into a single stream and broadcast that single stream to a plurality of receiving devices.

It has been discovered that, in a screen sharing and video conferencing system, the multiplexing of a plurality of captured video stream into a single stream and the broadcasting of that single stream to a plurality of receiving devices requires a reduced amount of bandwidth then when broadcasting the plurality of captured video streams individually.

It has been discovered that, in a screen sharing and video conferencing system, a section capture of a display area for being shared as a video stream requires a reduced amount of bandwidth when streaming the video stream in comparison with a streaming of a video stream representing a full capture of a display area.

According to one aspect, there is a screen sharing and video conferencing system. The system comprises a presenter device, one or more attendee devices and a streaming server. The streaming server being for receiving and rebroadcasting video and audio streams from the presenter and the attendee devices.

The presenter device comprises browser-based video and audio streaming components and an installed screen capture and system audio capture component. The browser-based video and audio streaming components being configured to transmit camera video and microphone audio to the streaming server and playback video and audio streams from the streaming server. The installed screen capture and system audio capture component being configured to compress and transmit video data from a desktop and/or video source of the presenter device and to transmit system audio to the streaming server.

The attendee devices comprise browser-based video and audio streaming components. The browser-based video and audio streaming components being configured to transmit camera video and microphone audio to the streaming server and playback video and audio streams from the streaming server of camera, microphone, system audio and screen capture sources.

According to another aspect there is a screen sharing method for streaming a multimedia stream between a presenter device and an attendee device. The method requires connecting the presenter device to a streaming server through a communication network. The method further requires connecting the attendee device to the streaming server through a communication network. Once both devices are connected to the streaming server, the method requires capturing a multimedia stream from the presenter device for streaming to the attendee device.

According to one embodiment, the multimedia stream is a video stream and an audio stream. The video stream is captured at an adjusted frame rate for maintaining a desired video stream quality at the attendee device. Both the video stream and the audio stream are encoded and sent to the streaming server. The streaming server then broadcasts the video stream and the audio stream to the attendee device.

According to another aspect there is a streaming server for a screen sharing and video conferencing system. The streaming server has a data receiving port, a broadcast port and a capture frequency establisher. The data receiving port is adapted to receive from at least one connected device at least one of a video or audio stream. The broadcast port is adapted to rebroadcast the at least one video or audio stream to other connected devices. The capture frequency establisher is adapted to determine a capture frequency indicator according to an available bandwidth.

According to another aspect, there is a presenter device for a screen sharing and video conferencing system. The presenter device has an installed screen capture component configured to compress and transmit video data from a display and/or video source of the presenter device to a streaming server of the system. The screen capture component is adapted to transmit the video data according to a frame capture frequency indicator.

According to another aspect, there is a screen sharing method for streaming a multimedia stream between a plurality of devices that are connected to a streaming server. The method requires capturing a first multimedia stream from a first one of the devices and capturing a second multimedia stream from a second one of the devices. Both, the first and second multimedia streams being either one of an audio stream or a video stream. The method further requires sending the first and second multimedia streams to the streaming server. The streaming server then multiplexes the streams by multiplexing the first multimedia stream with the second multimedia stream into a single multimedia stream. The single multimedia stream is then broadcasted to at least one of the plurality of devices.

### BRIEF DESCRIPTION OF THE DRAWINGS

The invention will be better understood by way of the following detailed description of embodiments of the invention with reference to the appended drawings, in which:

FIG. 1 illustrates a screen sharing system between a presenter device and at least one attendee devices, according to an embodiment;

FIG. 2A illustrates a display of the presenter device, according to an embodiment;

FIG. 2B illustrates a web browser displayed on a display of the attendee device, according to an embodiment;

FIG. 3 illustrates a sequence diagram of an interaction between processes of the presenter device that is connected to a communication network, according to an embodiment;

FIG. 4A illustrates a video streaming technique processed by a streaming server, according to an embodiment;

FIG. 4B illustrates a video streaming technique processed by a streaming server, according to an embodiment;

FIG. 5A illustrates an audio streaming technique processed by a streaming server, according to an embodiment;

FIG. 5B illustrates an audio streaming technique processed by a streaming server, according to an embodiment;

FIG. 5B illustrates an audio streaming technique processed by a streaming server, according to an embodiment;

FIG. 6 illustrates a method for streaming a multimedia stream between a presenter device and a attendee device, according to an embodiment; and

FIG. 7 illustrates a method for streaming a multimedia stream between a presenter device and an attendee device by multiplexing multimedia streams, according to an embodiment.

### DETAILED DESCRIPTION

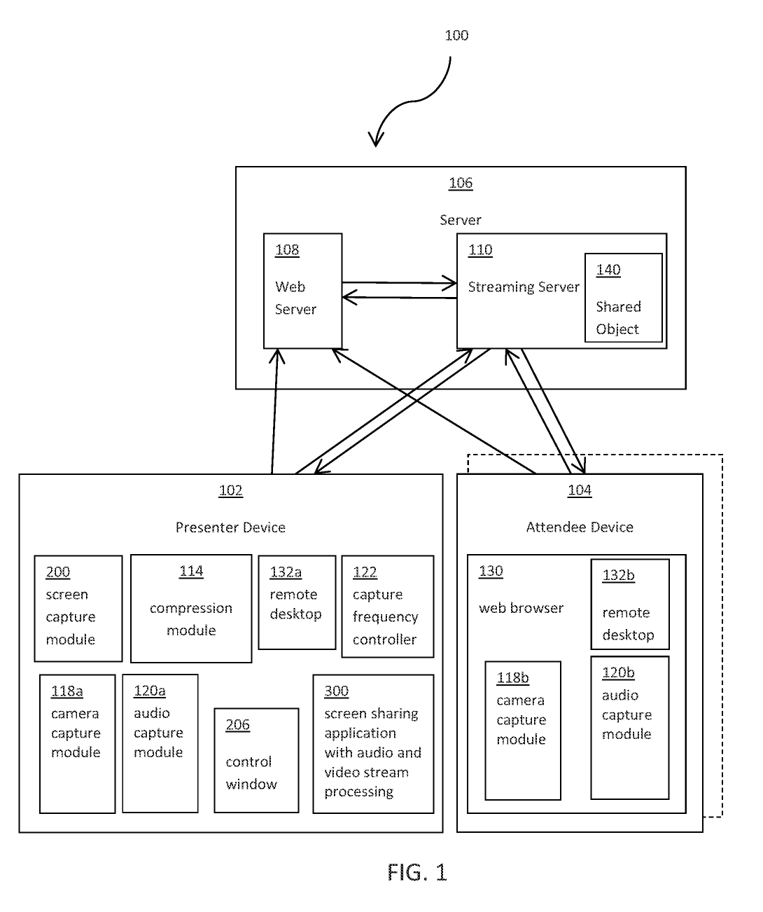

Illustrated in FIG. 1, there is a system 100 for screen sharing and video conferencing 100 between a presenter device 102 and an attendee device 104, both devices (102 and 104) are connectable to a server 106. The devices (102 and 104) are connectable to the server 106 through the internet or any other type of communication network such as a Local Area Network or a Wide Area Network. According to one aspect, the server 106 comprises a web server module 108 and a streaming server module 110, these modules may be collocated or remotely located. They may be connected through a communication network that is a same network as the one to which the devices (102 and 104) are connected or to a different network.

According to one embodiment, the user of the presenter device 102 may initialise a communication with a user of the attendee device 104 by first logging onto the system 100 via the web server 108. Once logged in the user may make a communication session request to the web server 108 for obtaining a session key. The user of the presenter device 102 may then inform the user of the attendee device 104 about the session key via email, phone or any other means of communication. A skilled reader will understand that the user of the attendee device 104 may further be informed about the session key by other means such as by the web server 108 or another device such as for example another attendee device 104.

The user of the attendee device 104 may then access a web site hosted by the server 106 by using the session key. The address of the web site must have been previously communicated to the user of the attendee device 104. According to one embodiment, once access of the web site is granted to the attendee device 104, there is displayed on the web site the screen display of the presenter's device 102. Depending on the type of communication established by the web server the attendee device 104 will be able to download various types of multimedia files via the web site and also upload multimedia files. Communication may be established for various reasons such as for web conferencing, for presenting a work, for providing technical support, for chatting with the users of the attendee devices 104 or for presenting a multimedia file as a streaming media such as a video stream or an audio stream.

The video stream may be from a screen capture when in screen sharing mode and/or may be from a webcam connected to the device (102 or 104) when in web conferencing mode. Similarly, the audio stream may be from a system soundcard of the device (102) when in screen sharing mode or may be from a microphone connected to the device (102 or 104) when in web conferencing mode. When in screen sharing mode, the presenter device (102) is adapted to upload a system audio stream and a screen capture video stream to the streaming server 110 and the attendee device (104) is adapted to download the system audio stream and the screen capture video stream from the streaming server 110. When in web conferencing mode, devices (102 or 104) are adapted to transmit a camera video stream and microphone audio stream to the streaming server 110 and also playback camera video stream and microphone audio stream from the streaming server 110.

A skilled person will understand that streaming media is multimedia that is constantly received by and presented to an end-user while being delivered by a streaming provider.

According to one embodiment of the system 100, the web site that is accessible to the attendee devices 104 has a Google Web Toolkit (GWT) interface, Flash is used for streaming connections and JavaScript is used for communication between GWT and Flash. There is therefore no need to install software on the attendee device 104 for receiving or sending a multimedia file.

The streaming server 110 is used for processing at least one multimedia file that has been uploaded by the presenter device 102 and that is for being downloaded by the attendee device 104, once a connection is established between the streaming server 110 and both devices (102 and 104). For establishing such a connection, the streaming server 110 first authenticates the users of each device (102 and 104) by accessing the user profile defined in the web server 108. If permission is granted for the devices (102 and 104) to be connected for using a particular web service, the streaming server 110 then provides for managing multimedia streams such as audio, video or screen sharing streams.

The streaming server 110 further comprises shared objects 140 to which every user is connected, such as objects 140 to inform each user about the current conference attendees, information about the shared screen, chat messages and general notifications, and the list with the currently enabled audio streams.

The web server 108 is adapted to manage presenter user profiles, manage communication session connections and store previously recorded communications between the devices (102 and 104). According to one embodiment, it is required for a device (102 or 104) to establish a connection with the web server 108 for accessing the user profile or a recorded communication that has been stored on the web server 108.

### Screen Capture

According to one embodiment, there is locally installed on the presenter device 102 a software for allowing the user to make a screen capture of his own screen display. In this case, the software is a Java applet however the software may be any other type of software that allows a user to make such a screen capture.

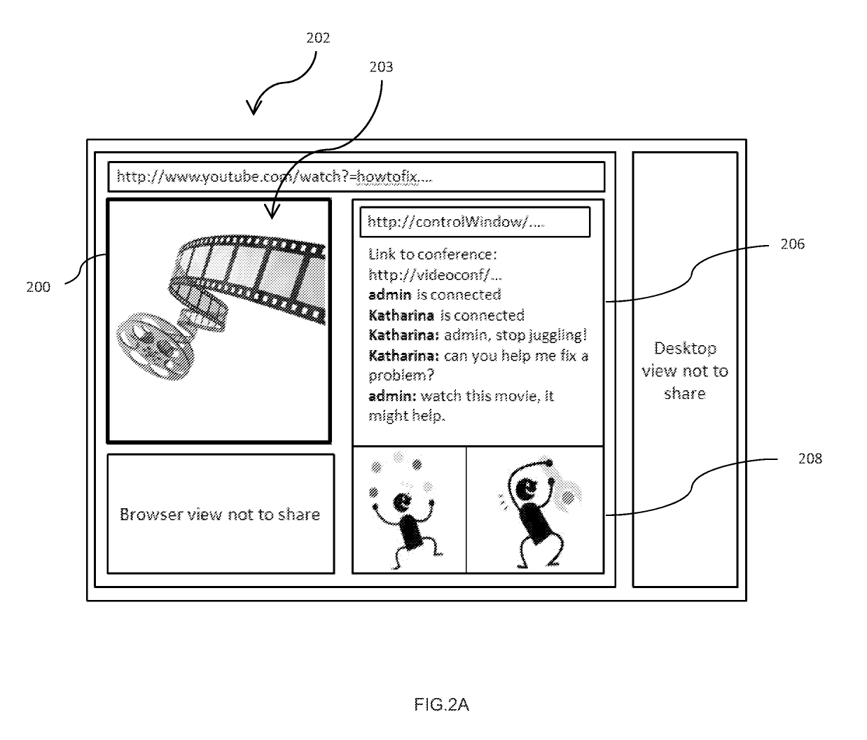

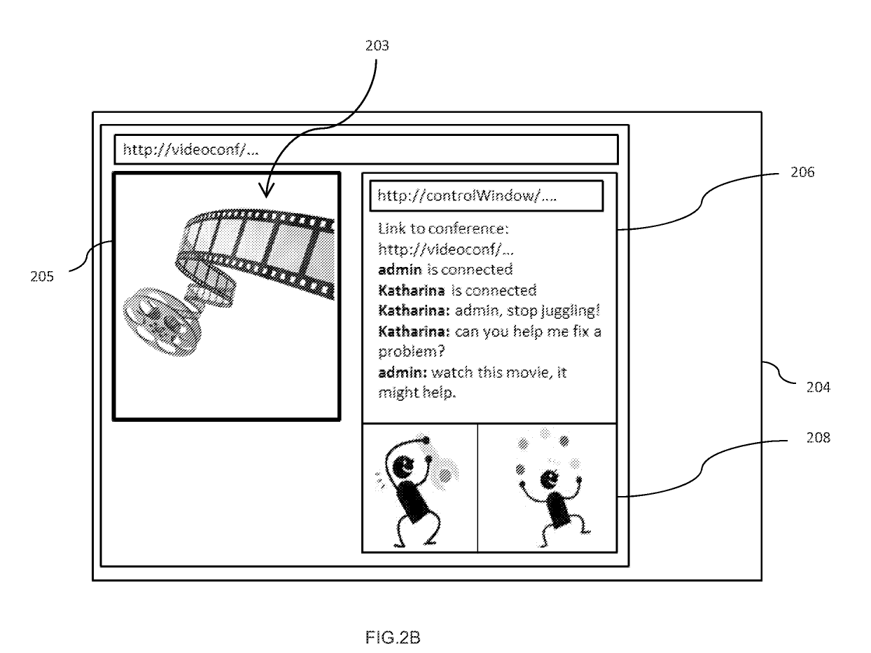

As presented in FIG. 2A, the system 100 is adapted to provide a screen capturing means 200 for defining a portion of the screen display to be broadcasted. The application captures the device's 102 screen display 202 within a square zone 200 dimensioned by the user of the device 102. All elements 203 present in the square zone 200 are then broadcasted via a web site to the attendee device 104. As presented in FIG. 2B, the user of the device 104 can view on his screen 204 those elements 203 captured from the screen display 202 within a zone 205.

According to one embodiment, the screen captures are used to build in real time a flash-based video that is broadcasted to the attendee devices 104 with Real Time Messaging Protocol (RTMP) as it is being built. Video compression, such as H.264 or (Advanced Video Coding) AVC, is used to reduce bandwidth usage. The video is built by an application that uses native code specifically for each operating system and is loaded by the Java applet that is integrated in a control window 206 of the presenter device 102. For this operation, the presenter device 102 needs to have Java installed to automatically download the applet.

### Screen Sharing Technique

According to one aspect, the present system is adapted to broadcast a video stream acquired from a screen capture by the screen capturing means 200 of the presenter device 102. The screen display content may represent various applications that have been instantiated in the presenter device 102. One application that may be instantiated in the presenter device 102 is a web browser displaying a video stream by being connected to a video-sharing website such as YouTube™. The system 100 is adapted to broadcast the displayed video stream of the presenter device 102 to the attendee devices 104 without compromising the fluidity of the video-sharing streaming web site. The screen display is captured at a similar frequency to the video-sharing website.

According to one embodiment, the presenter device 102 has a capture frequency controller 122 for controlling the screen display capture frequency as defined by the user of the presenter device 102. The user of the presenter device 102 may define the screen display capturing frequency according to the available bandwidth capacity and the type of video stream to share. When the available bandwidth capacity is low, the user may reduce the screen display capture frequency. However when the available bandwidth capacity is high, the user may increase the screen display capture frequency to increase the perceived fluidity of video stream by the user of the attendee device 104. In the case where the nature of the video stream allows using a lowered capture frequency without affecting the perceived fluidity of the video stream, the user may decrease the capture frequency accordingly. Similarly, when the video stream requires a higher capture frequency for enhancing the perceived fluidity of the video stream, the user may increase the capture frequency accordingly, as long as the available bandwidth permits it.

According to another embodiment, the screen display capture frequency is predetermined and is set to twenty frames per second.

According to yet another embodiment, there are various predetermined screen display capture frequencies where a minimum is set to fifteen frames per second and a maximum is set to thirty frames per second. A skilled reader will understand that a maximum capture frequency is dependant of the regional video standards. For instance, in North America the standard is thirty frames per second therefore a higher capture frequency than thirty frames per second would not alter the perceived fluidity of the video.

According to another aspect, further enhancement of the performance of the system 100 is provided by leveraging multi-core architecture systems on the attendee device 104 whenever possible.

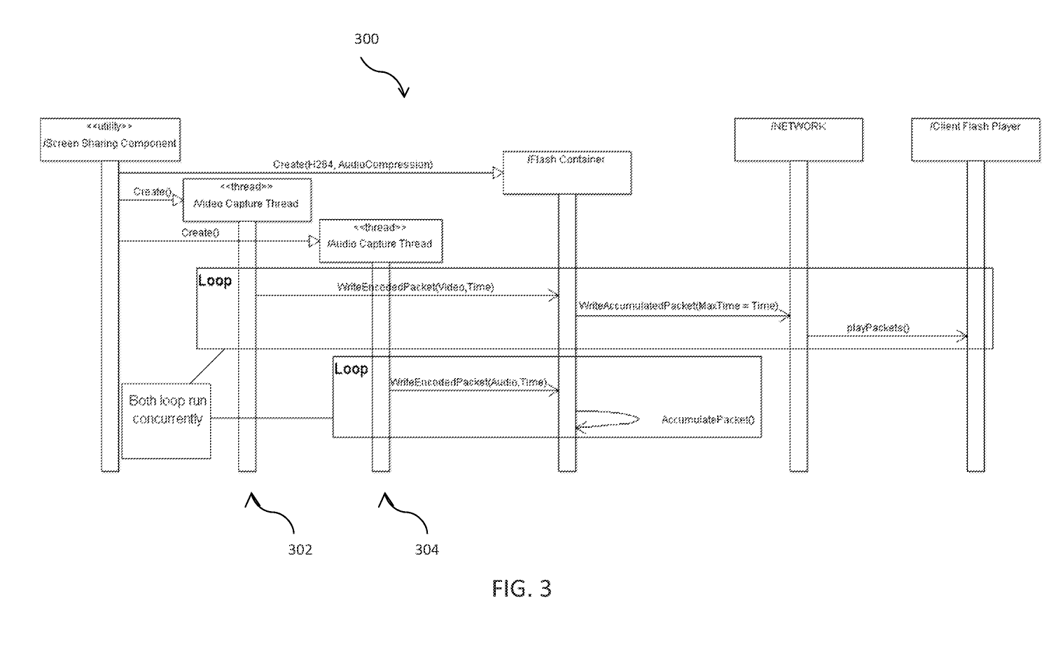

There is presented in FIG. 3 a sequence diagram representing various functions of a screen sharing application 300 installed at the presenter device 102 and the interaction between the screen sharing application 300 with the network. According to one embodiment, the system 100 is adapted to perform parallel processing techniques for simultaneously broadcasting a video stream 302 and an audio stream 304. The presenter device 102 is adapted to start a first thread to broadcast the video stream 302 and a second thread to broadcast the audio stream 304. In this manner the audio stream 304 broadcast can be stopped or restarted without disrupting the video stream 302 broadcast. Similarly, the video stream 302 broadcast can be stopped or restarted without disrupting the audio stream 304 broadcast. According to one embodiment, one of the video stream 302 or audio stream 304 broadcast is automatically stopped by the application when there is detected an insufficient transmission bandwidth.

According to another aspect, as presented in FIG. 3 the application 300 is adapted to manage automatically and in real-time the screen capture intervals. The application 300 is able to synchronize both audio and video streams with a minimum of buffering and at the same time avoid the cumulative effect of variable screen capture timing offsets (i.e. timing offsets between the audio and video streams).

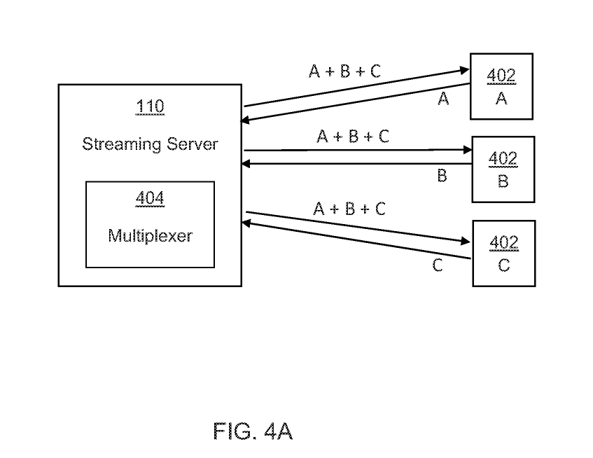

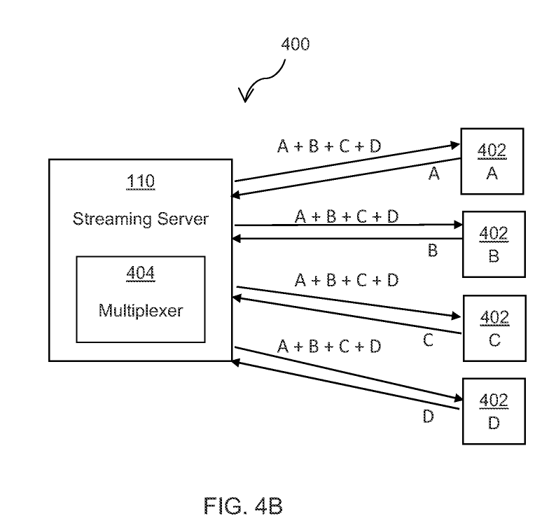

According to yet another aspect and as presented in FIG. 4A, there are multiple video streams (A, B and C) that are sent to the streaming server for being redistributed. The multiple video streams being each a screen capture provided by a different device 402 (such as the presenter device 102 and the attendee device 104).

According to one embodiment and as further presented in FIG. 4A, at least a plurality of the video streams (A,B, and C) are redistributed to at least one of the devices 402. It is known that the video streaming over the internet may consume quite a lot of bandwidth depending on various factors such as the number of video streams, the quality level of each video stream and their level of compression. To diminish the bandwidth usage, the streaming server 110 uses a multiplexer 404. The multiplexer 404 is adapted to apply a multiplexing technique for combining the at least plurality of incoming video streams (A,B and C) into one video stream (ex.: A+B+C) and send the single video stream (A+B+C) to at least one of the devices 402.

The multiplexing technique 400 allows to provide a lower use of bandwidth than in a simple broadcasting of all screen captured video streams. As presented in FIG. 4B, this technique 400 allows for a new device 402 to join without exponentially increasing the total number of video streams produced by each device 402. In this case, the streaming server only counts one more incoming video stream (D) and one more outgoing stream (i.e. A+B+C+D).

### Webcam Video Stream Technique

As presented in FIG. 1 according to one embodiment, the screen sharing system 100 is adapted to provide video conferencing capabilities. A camera capture module (118a and 118b) is used in both presenter and attendee devices (102 and 104), for capturing a webcam video stream of each device (102 and 104) user and transmitting the video streams in real-time to the other devices (102 and/or 104). According to one embodiment and as presented in FIGS. 2A and 2B, the control window 206 has a webcam display section 208 for displaying the captured webcam video stream of each participating user (i.e. presenter and attendee).

According to one embodiment, the webcam capture module (118a and 118b) is a Flash-based application that is adapted to acquire a webcam video stream from a webcam connected to each respective device (102 and/or 104) and transmit the webcam video stream to the streaming server 110. The streaming server 110 then redistributes each webcam video stream to the other devices (102 and/or 104). Although the webcam video stream in this embodiment is acquired from a webcam, a skilled person will understand that the webcam video stream may be acquired by any other video acquiring means.

The video streaming over the internet may consume quite a lot of bandwidth depending on various factors such as the number of video streams, the quality level of each video stream and their level of compression. To diminish the bandwidth usage, the streaming server 110 uses a multiplexer 404, as presented in FIG. 4A. The multiplexer 404 is adapted to apply a multiplexing technique for combining all the incoming webcam video streams (A,B and C) of devices 402, such as the presenter device 102 and the attendee device 104, into one video stream (A+B+C) and send a single video stream to each device 402.

The multiplexing technique 400 allows to provide a lower use of bandwidth than in a simple broadcasting of all webcam video streams. As presented in FIG. 4B, this technique 400 allows for a new device 402 to join without exponentially increasing the total number of video streams produced by each webcam. In this case, the streaming server only counts one more incoming webcam video stream (D) and one more outgoing stream (i.e. A+B+C+D).

It shall be understood that it is possible for the multiplexer 404 to apply the multiplexing technique for combining various types of video streams such as webcam video streams, screen capture video streams, etc.

### Audio Stream Technique

According to one embodiment, the screen sharing system 100 provides audio conferencing capabilities. As presented in FIG. 1, an audio capture module (120a and 120b) is used in both presenter and attendee devices (102 and 104), for capturing an audio stream of each device (102 and 104) user and transmitting the audio streams in real-time to the other devices (102 and/or 104).

According to one embodiment, the audio capture module (120a and 120b) is a Flash-based application that is adapted to acquire an audio stream from a microphone connected to each respective device (102 and/or 104) and transmit the audio stream to the streaming server 110. The streaming server 110 then redistributes each audio stream to the other devices (102 and/or 104). Although the audio stream in this embodiment is acquired from a microphone, a skilled person will understand that the audio stream may be acquired by any other audio acquiring means such as an audio stream from a video sharing website or from a device's sound card.

It is to be understood that the following described technique is also applicable for broadcasting audio when video conferencing.

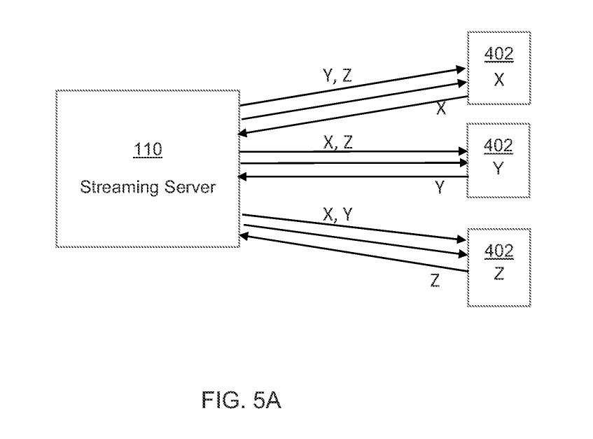

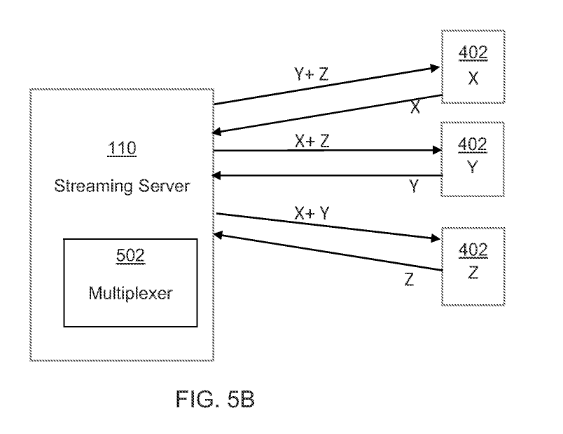

According to one embodiment and as presented in FIG. 5A, in contrast to the treatment of the webcam streams (i.e. multiplexing the videos to a single stream), the streaming server 110 does not join the audio streams (X,Y,Z) coming from the devices 402. Consequently, each device 402 receives separate audio streams for each other device 402 connected to the conference. The user of a device 402 does not receive his own audio stream to avoid that he/she hears himself/herself. Thereby, the user has no echo of his own voice. The server only does a broadcasting and does no other procedures as a treatment for the audio streams, requiring little server resources. Although every new attendee increases the number of incoming audio streams for the other users and consequently also the used bandwidth, as the audio stream uses in general much less bandwidth than the video stream the impact of sending separate audio streams to each device 402 is lower. Moreover, with “Voice Activity Detection” (VAD) enabled a client does not send audio packets when the activity of the microphone is too low. This means that there is no consumption of bandwidth when a user does not speak.

### Audio Stream Multiplexing Technique

According to another embodiment as presented in FIG. 5B, the audio streams (X,Y and Z) are multiplexed by a multiplexer 502 of the streaming server 110. For avoiding an echo of each user's voice, the multiplexor produces a multiplexed stream for each device 402 (i.e. a stream with Y+Z for X, a stream with X+Z for Y, and a stream with X+Y for Z). This technique reduces the used bandwidth.

### Remote Desktop

According to another aspect, the system 100 is adapted to provide a “Remote Desktop” functionality to both the presenter device 102 and the attendee device 104. The “Remote Desktop” functionality allows a user of the presenter device 102 to interact with the shared desktop of the attendee device and further allows a user of the attendee device 102 to interact with the shared desktop of the presenter device.

An installation of a remote desktop application 132a is required at the presenter device 102 however no installation is required at the attendee device 104. The attendees require no special installation as a web based remote desktop module 132b sends the mouse position of the attendee device 104 to a shared object 140 such as a cursor location module. The mouse position is then processed by the remote desktop application 132a and displayed on the screen of the presenter device 102. According to one embodiment, the remote desktop application 132a is a Java based application and the web based remote desktop module 132b uses Java Script and Flash components.

According to one embodiment, the user of the presenter device 102 gives permission to the attendee device 104 to interact with the shared screen. The web based remote desktop module 132b of the attendee device 104 listens on Mouse- and Keyboard-Events. If the user of the attendee device 104 clicks somewhere on the shared screen, the position of the mouse is captured and sent via JavaScript to a Flash component which updates a shared object 140 on the streaming server 110. If a shared object 140 receives an update, it sends automatically an event to all devices (102 and 104). The presenter device 102 is then notified of the mouse click and its position, the remote desktop module 132a then simulates a real mouse click on the presenter device's screen 102.

### Screen Sharing Method

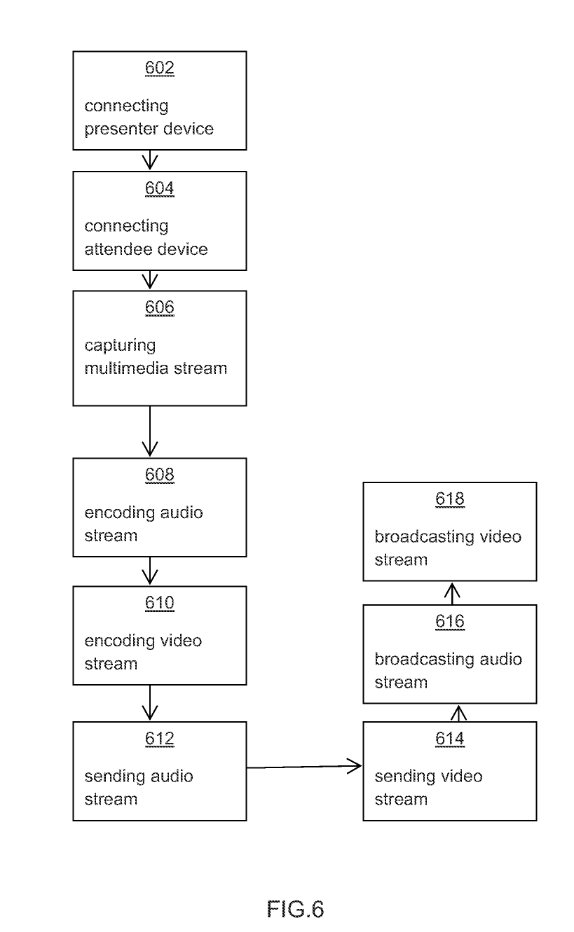

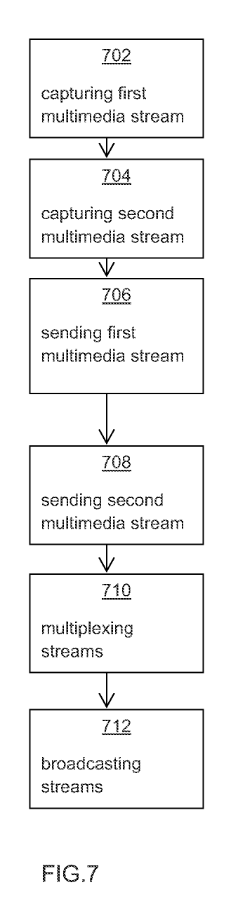

According to another aspect and as presented in FIG. 6, there is a screen sharing method 600 for streaming a multimedia stream between a presenter device 102 and an attendee device 104. The method 600 requires connecting the presenter device 102 to a streaming server 110 through a communication network. The method 600 further requires connecting the attendee device 104 to the streaming server 110 through a communication network. Once both devices (102 and 104) are connected to the streaming server 110, the method 600 requires capturing a multimedia stream from the presenter device 102 for streaming to the attendee device 104.

According to one embodiment, the multimedia stream is a video stream 302 and an audio stream 304. The video stream 302 is captured at an adjusted frame rate for maintaining a desired video stream quality at the attendee device 104. The adjusted frame rate could be adjusted by the user of the presenter device 104 or could be automatically adjusted according, for instance, to an available bandwidth capacity. Both the video stream 302 and the audio stream 304 are encoded (608 and 610) and sent (612 and 614) to the streaming server 110. The streaming server 110 then broadcasts (616 and 618) the video stream 302 and the audio stream 304 to the attendee device 104. The broadcast (616 and 618) can be done via a software application installed on the attendee device 104 or via a web site to which the attendee device 104 is connected.

According to another aspect, there is a screen sharing method 700 for streaming a multimedia stream between a plurality of devices, such as a presenter device 102 or an attendee device 104, that are connected to a streaming server 110. The method 700 requires capturing a first multimedia stream 702 from a first one of the devices and capturing a second multimedia stream 704 from a second one of the devices. Both, the first and second multimedia streams being either one of an audio stream or a video stream. The method 700 further requires sending the first and second multimedia streams (706 and 708) to the streaming server 110. The streaming server 110 then multiplexes the streams by multiplexing 710 the first multimedia stream with the second multimedia stream into a single multimedia stream. The single multimedia stream is then broadcasted 712 to at least one of the plurality of devices.

What is claimed is:

1. A screen sharing and video conferencing system comprising:
a presenter device;
one or more attendee devices;
a streaming server for receiving and rebroadcasting video and audio streams from the presenter and the one or more attendee devices;
wherein the presenter device comprises:
browser-based video and audio streaming components configured to transmit camera video and microphone audio to the streaming server and playback video and audio streams from the streaming server;
an installed screen capture and system audio capture component configured to compress and transmit video data from a desktop and/or video source of the presenter device and to transmit system audio to the streaming server; and
wherein the one or more attendee devices comprise:
browser-based video and audio streaming components configured to transmit camera video and microphone audio to the streaming server and to receive and to playback video and audio streams from the streaming server of camera, microphone, system audio and screen capture sources.

2. The system as claimed in claim 1, wherein the streaming server combines the camera video streams into a single frame stream.

3. The system as claimed in claim 1, wherein the streaming server combines the camera video streams and the screen capture video stream into a single frame stream.

4. The system as claimed in claim 1, wherein the streaming server determines available bandwidth for the one or more attendee devices and controls transmission of said video and audio streams according to priority.

5. The system as claimed in claim 1, wherein the streaming server further comprises a shared object module accessible by the presenter device and the one or more attendee devices.

6. The system claimed in claim 5 wherein the shared object module is a presenter cursor location module that is updatable by a mouse cursor location of the one or more attendee devices for controlling the mouse cursor location of the presenter device.

7. A streaming server for a screen sharing and video conferencing system comprising:
a capture frequency establisher that is adapted to determine a capture frequency indicator according to an available bandwidth;
a data receiving port adapted to receive from at least one connected device at least one of a video or audio stream, the video stream being captured according to the capture frequency indicator; and
a broadcast port adapted to rebroadcast the at least one video or audio stream to other connected devices.

8. The streaming server of claim 7 wherein the capture frequency indicator is dynamically determined according to the available bandwidth.

9. The streaming server of claim 7 further comprising a data sending port that is adapted to send the capture frequency indicator to the at least one connected device.

10. The streaming serve of claim 7 further comprising a multiplexer that is adapted to multiplex the at least one video or audio stream into a single video or audio stream for being rebroadcasted.

11. A presenter device for a screen sharing and video conferencing system comprising an installed screen capture component configured to compress and transmit video data from a display and/or video source of the presenter device to a streaming server of the system, the screen capture component being adapted to transmit the video data according to a frame capture frequency indicator.

12. The presenter device of claim 11 further comprising a capture frequency controller adapted to determine the frame capture frequency indicator according to an available bandwidth.

13. The presenter device of claim 11, wherein the frame capture frequency indicator is dynamically determined according to an available bandwidth.

14. A screen sharing method for streaming a multimedia stream between a presenter device and an attendee device, the method comprising:
connecting the presenter device to a streaming server through a communication network;
connecting the attendee device to the streaming server through a communication network;
capturing a multimedia stream from the presenter device for streaming to the attendee device, wherein the multimedia stream comprises an audio stream and a video stream, the video stream being captured at an adjusted frame rate for maintaining a desired video stream quality at the attendee device;
encoding the audio stream;
encoding the video stream;
sending the audio stream and the video stream to the streaming server; and
broadcasting the video stream and the audio stream to the attendee.

15. The method of claim 14 wherein the adjusted frame rate is an automatically adjusted frame rate according to the available bandwidth capacity.

16. The method of claim 14 wherein the broadcasting is done via a web site to which the attendee device is connected.

17. The method of claim 14 wherein the encoding of the audio stream and the encoding of the video stream are processed in parallel at the presenter device.

18. A screen sharing method for streaming a multimedia stream between a plurality of devices that are connected to a streaming server, the method comprising:
capturing a first multimedia stream from a first one of the devices;
capturing a second multimedia stream from a second one of the devices;
sending the first multimedia stream to the streaming server;
sending the second multimedia stream to the streaming server;
multiplexing the first multimedia stream with the second multimedia stream into a single multimedia stream; and
broadcasting the single multimedia stream to at least one of the plurality of devices.

19. The method of claim 18 wherein the first multimedia stream and the second multimedia stream are video streams.

20. The method of claim 19 wherein the video streams are captured with a camera, the camera being connected to one of the plurality of devices.

21. The method of claim 18 wherein the first multimedia stream and the second multimedia stream are audio streams, each audio stream being captured from a microphone connected to a respective device wherein, the broadcasting of the single multimedia stream is to at least one of the plurality of devices other than the first one of the devices and the second one of the devices.

22. The method of claim 18 wherein the first video stream and second video stream are captured at an adjusted frame rate for maintaining a desired video stream quality at a receiver device and where the receiver device is one of the plurality of devices.
